(19) United States
(12) Patent Application Publication
(10) Pub. No.: US 2009/0128897 A1
(43) Pub. Date: May 21, 2009

(54) MICROSCOPE HAVING MULTIPLE IMAGE- OUTPUTTING DEVICES AND PROBING APPARATUS FOR INTEGRATED CIRCUIT DEVICES USING THE SAME

(75) Inventors: Yong Yu Liu, Sanchong City (TW); Choon Leong Lou, Singapore (SG)

Correspondence Address: CONNOLLY BOVE LODGE & HUTZ LLP, 1875 EYE STREET, N.W., SUITE 1100, WASHINGTON, DC, 20006, US

(73) Assignee: Star Technologies Inc., Hsinchu County (TW)

(21) Appl. No.: 12/015,775

(22) Filed: Jan. 17, 2008

(30) Foreign Application Priority Data
Nov. 21, 2007 (TW) 096144013

(51) Int. Cl. G02B 21/18; G02B 21/06; H04N 7/18

(52) U.S. Cl. 359/372; 359/389; 348/79; 348/E07.085; 359/368

(57) ABSTRACT

A microscope comprises an object splitter and a plurality of image-outputting devices configured to receive object images. The object splitter includes a first beam splitter configured to direct an illumination light to an object, a positive lens configured to collect a reflected light from the object and focus the reflected light on the first beam splitter, a second beam splitter configured to split the reflected light into a plurality of optical paths and a plurality of negative lenses positioned on the optical paths to render object images. A probing apparatus for an integrated circuit device comprises at least one probe pin configured to contact a pad of the integrated circuit device and a microscope including an object splitter and a plurality of image-outputting devices configured to receive images from the object splitter.

### BACKGROUND OF THE INVENTION

(A) Field of the Invention

The present invention relates to a microscope having multiple image-outputting devices and a probing apparatus for an integrated circuit device using the same, and more particularly, to a microscope having multiple image-outputting devices and capable of continuous zooming and auto-focusing and a probing apparatus for an integrated circuit device using the same.

(B) Description of the Related Art

Optical microscopes have been adapted for viewing objects on planar surfaces of glass slides. Such microscopes generally include an optical system, which provides an image of the object in an associated focal plane. The optical components of an optical microscope are two imaging lenses (eyepiece and objective) and a condenser lens. The eyepiece and objective are responsible for magnifying the image of the specimen and projecting it onto the viewer's retina or onto the film plane in a camera. The job of the condenser lens is to focus a cone of incident light onto the specimen. To provide the incident light, there is an illumination system that may include the source of the incident light or may direct external natural or artificial light towards the condenser lens. It can also provide means for enhancing the contrast and detail seen in the image. Finally, there is a movable stage, which holds the specimen in the optical path and allows the specimen to be moved in and out of the focal plane and even left, right and rotated about the optic axis.

US patent publication number 2005/0094021 A1 discloses an optical system incorporating an auto-focus camera with built-in close-up optics for easy coupling to any imaging optical system via standard C-mount; however, such system has the drawback of having only one optical path and thus is only a single view system.

### SUMMARY OF THE INVENTION

One aspect of the present invention provides a microscope having multiple image-outputting devices, which is capable of continuous zooming and auto-focusing.

A microscope according to this aspect of the present invention comprises an object splitter and a plurality of image-outputting devices configured to receive object images. The object splitter includes a first beam splitter configured to direct an illumination light to an object, a positive lens configured to collect a reflected light from the object and focus the reflected light on the first beam splitter, a second beam splitter configured to split the reflected light into a plurality of optical paths and a plurality of negative lenses positioned on the optical paths to render object images.

Another aspect of the present invention provides a probing apparatus for an integrated circuit device comprising at least one probe pin configured to contact a pad of the integrated circuit device and a microscope including an object splitter configured to direct an illumination light to a predetermined region where the probe pin contacts the pad and splits a reflected light from the predetermined region into a plurality of optical paths and a plurality of image-outputting devices positioned on the optical paths to receive images from the object splitter.

### BRIEF DESCRIPTION OF THE DRAWINGS

The objectives and advantages of the present invention will become apparent upon reading the following description and upon reference to the accompanying drawings in which:

FIG. 1 illustrates a microscope according to one embodiment of the present invention; and

FIG. 2 illustrates a probing apparatus for an integrated circuit device 60 according to one embodiment of the present invention.

### DETAILED DESCRIPTION OF THE INVENTION

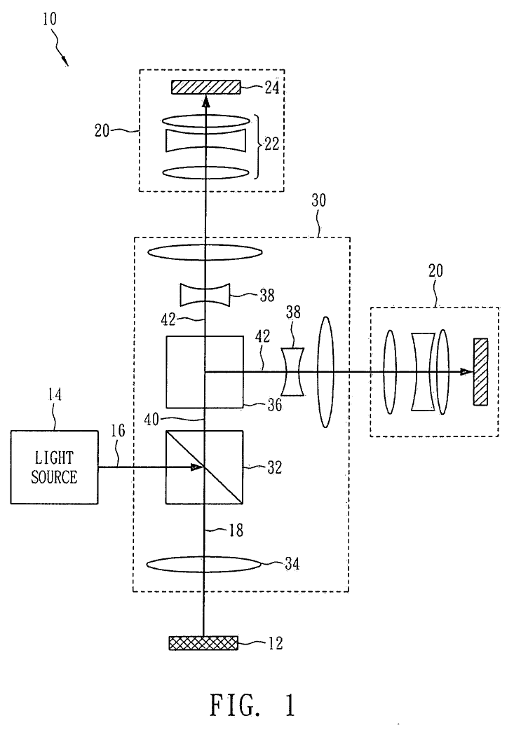

FIG. 1 illustrates a microscope 10 according to one embodiment of the present invention. The microscope 10 comprises an object splitter 30 and a plurality of image-outputting devices 20 configured to receive object images. The object splitter 30 includes a light source 14 configured to emit an illumination light 16, a first beam splitter 32 configured to direct the illumination light 16 to an object 12, a positive lens 34 configured to collect a reflected light 18 from the object 12 and focus the reflected light 18 on the first beam splitter 32, a second beam splitter 36 configured to split the reflected light 18 into a plurality of optical paths 42 and a plurality of negative lenses 38 positioned on the optical paths 42 to render object images.

Preferably, the first beam splitter 32, the positive lens 34 and the second beam splitter 36 are positioned on an optical axis 40, and the object splitter 30 is configured to direct the illumination light 16 to the object 12 through the optical axis 40. In particular, the positive lens 34 is configured to allow the illumination light 16 to penetrate through to the object 12, and allow the reflected light 18 to penetrate through to the first beam splitter 32. The first beam splitter 32 is configured to allow the reflected light 18 to penetrate through to the second beam splitter 36. Preferably, the image-outputting devices 20 are zoom cameras 20, and each zoom camera 20 includes a plurality of zoom lenses 22 configured to magnify the object image and an image sensor 24 configured to sense the magnified image. Furthermore, the zoom lenses 22 also allow continuous zoom adjustments with auto-focus capability. Consequently, the zoom cameras 20 can be configured to acquire the object images at different zooms individually.

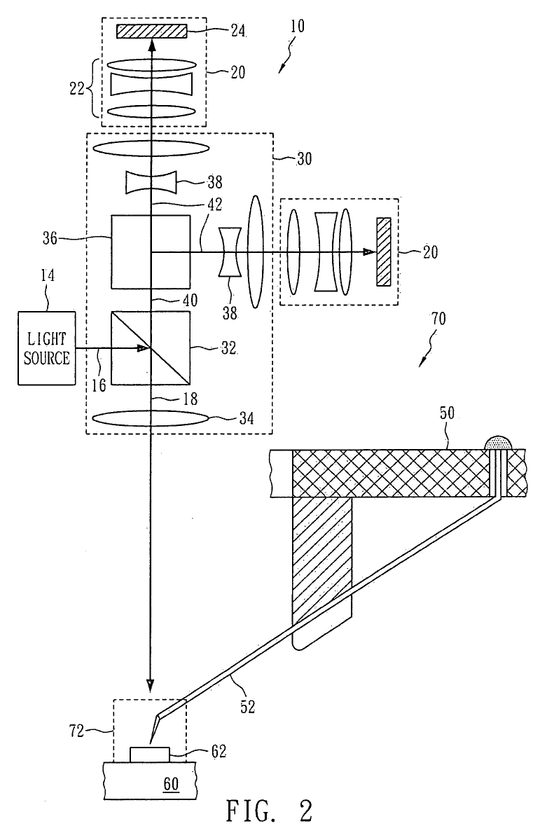

FIG. 2 illustrates a probing apparatus 70 for an integrated circuit device 60 according to one embodiment of the present invention. The probing apparatus 70 can be a probing machine having a platform to receive a probing card 50 including at least one probe pin 52 configured to contact a pad 62 of the integrated circuit device 60 and the microscope 10 configured to show the images of a predetermined region. 72 where the probe pin 52 contacts the pad 62 at different zooms. In particular, the microscope 10 can simultaneously provide multiple views of the predetermined region 72 and each view with different zoom setting such that the user of the probing apparatus 70 can observe the images of the predetermined region 72 at different zooms simultaneously. In addition, the microscope 10 also allows each view to have continuous but separate zoom adjustments with auto-focus capability. Hence, the microscope 10 totally eliminates the need to adjust individual focusing when the probe pin 52 is moved and/or when zoom settings are changed.

The above-described embodiments of the present invention are intended to be illustrative only. Numerous alternative embodiments may be devised by those skilled in the art without departing from the scope of the following claims.

What is claimed is:

1. A microscope, comprising:
an object splitter, including:
a first beam splitter configured to direct an illumination light to an object;
a positive lens configured to collect a reflected light from the object and focus the reflected light on the first beam splitter;
a second beam splitter configured to split the reflected light into a plurality of optical paths; and
a plurality of negative lenses positioned on the optical paths to render object images; and
a plurality of image-outputting devices configured to receive the object images from the negative lenses.

2. The microscope of claim 1, wherein the positive lens is configured to allow the illumination light to penetrate through to the object.

3. The microscope of claim 1, wherein the positive lens is configured to allow the reflected light to penetrate through to the first beam splitter.

4. The microscope of claim 1, wherein the first beam splitter is configured to allow the reflected light to penetrate through to the second beam splitter.

5. The microscope of claim 1, wherein the first beam splitter, the positive lens and the second beam splitter are positioned on an optical axis, and the object splitter is configured to direct the illumination light to the object through the optical axis.

6. The microscope of claim 1, wherein the image-outputting devices are cameras configured to acquire the object images at different zooms.

7. The microscope of claim 6, wherein the cameras include a plurality of zoom lenses configured to magnify the object images.

8. The microscope of claim 1, further comprising a light source configured to emit the illumination light to the first beam splitter.

9. A probing apparatus for an integrated circuit device, comprising:
at least one probe pin configured to contact a pad of the integrated circuit device; and
a microscope, including:
an object splitter configured to direct an illumination light to a predetermined region where the probe pin contacts the pad and splits a reflected light from the predetermined region into a plurality of optical paths; and
a plurality of image-outputting devices positioned on the optical paths to receive images from the object splitter.

10. The probing apparatus for an integrated circuit device of claim 9, wherein the object splitter includes:
a first beam splitter configured to direct the illumination light to the predetermined region;
a positive lens configured to collect the reflected light from the predetermined region and focus the reflected light on the first beam splitter;
a second beam splitter configured to split the reflected light into the optical paths; and
a plurality of negative lenses positioned on the optical paths to render the images.

11. The probing apparatus for an integrated circuit device of claim 10, wherein the positive lens is configured to allow the illumination light to penetrate through to the predetermined region.

12. The probing apparatus for an integrated circuit device of claim 10, wherein the positive lens is configured to allow the reflected light to penetrate through to the first beam splitter.

13. The probing apparatus for an integrated circuit device of claim 10, wherein the first beam splitter is configured to allow the reflected light to penetrate through to the second beam splitter.

14. The probing apparatus for an integrated circuit device of claim 10, wherein the first beam splitter, the positive lens and the second beam splitter are positioned on an optical axis, and the object splitter is configured to direct the illumination light to the predetermined region through the optical axis.

15. The probing apparatus for an integrated circuit device of claim 10, wherein the image-outputting devices are cameras configured to acquire the images at different zooms.

16. The probing apparatus for an integrated circuit device of claim 15, wherein the cameras include a plurality of zoom lenses configured to magnify the images.

17. The probing apparatus for an integrated circuit device of claim 10, further comprising a light source configured to emit the illumination light to the first beam splitter.
